(19) United States
(12) Patent Application Publication
(10) Pub. No.: US 2013/0103187 A1
(43) Pub. Date: Apr. 25, 2013

(54) "SHOPPING CART" PARADIGM FOR SINGLE- OR MULTI-VEND VENDING MACHINE TRANSACTION PROCESS FLOW

(71) Applicants: James M. Canter, Austin, TX (US); William C. Royal, JR., Oak Ridge, NC (US); Troy Doom, North Augusta, SC (US); Bryan W. Godwin, Round Rock, TX (US)

(72) Inventors: James M. Canter, Austin, TX (US); William C. Royal, JR., Oak Ridge, NC (US); Troy Doom, North Augusta, SC (US); Bryan W. Godwin, Round Rock, TX (US)

(73) Assignee: CRANE MERCHANDISING SYSTEMS, INC., Bridgeton, MO (US)

(21) Appl. No.: 13/451,398

(22) Filed: Apr. 19, 2012

Related U.S. Application Data
(60) Provisional application No. 61/477,078, filed on Apr. 19, 2011.

(51) Int. Cl. G06F 17/00

(52) U.S. Cl. CPC G06F 17/602
USPC 700/232

(57) ABSTRACT

A vending machine is configured to provide a shopping cart vend transaction order-of-processing, allowing the customer to aggregate product selections before payment. The vending machine includes an enclosure configured to store a plurality of products, a user interface configured to receive inputs from a consumer; and a control system coupled to the user interface. The control system is configured to provide a virtual shopping cart that enables the customer to aggregate one or more product selections in a single vend transaction.

### CROSS-REFERENCE TO RELATED APPLICATIONS

This application claims priority to U.S. Provisional Patent Application Ser. No. 61/477,078, entitled “SHOPPING CART” PARADIGM FOR SINGLE- OR MULTI-VEND VENDING MACHINE TRANSACTION PROCESS FLOW and filed on Apr. 19, 2011. The content of the above-identified patent document is incorporated herein by reference.

### TECHNICAL FIELD

The present application relates generally to vending machine transactions and, more specifically, to a payment last order-of-processing facilitating multi-vend transactions and combination discounting.

### BACKGROUND

Vending machines offer unattended sales of commodities such as snacks, canned or bottled beverages, or any of a variety of other articles. The normal order-of-processing for a vending machine transaction generally involves payment by a customer, selection of the desired product by the customer, delivery by the product dispensing system of the vending machine, and then return of change to the customer if necessary. However, this order-of-processing imposes several constraints on vending machine sales. For example, “combo” sales or multi-vend transactions involving a sale of multiple products for a reduced aggregate price are inhibited, and generally limited to offering pre-selected product combinations or a reduced price for a second purchase during a limited period following completion of a first vend transaction. “Up-selling” and other advertisement or promotion opportunities during a vend transaction are therefore reduced if not completely eliminated.

Payment-selection-delivery order-of-processing for vend transactions also complicates cashless (e.g., credit or debit card) transactions, particularly where the vend products offered correspond to a substantial range of product prices or for multi-vend transactions. If payment is required before product selection, authorization of the transaction may involve placing a “hold” on an amount of funds corresponding to the highest product price, even when a much lower-priced product is actually purchased. Generally, that “hold” is not immediately released by the customer's financial institution upon completion (or even cancellation) of the transaction, which may annoy the customer. For multi-vend transactions, multiple holds may be necessary.

### SUMMARY

A shopping cart vend transaction order-of-processing allowing the customer to aggregate product selections before payment brings familiar purchasing sequences to vending transactions, facilitates multi product purchase discounting, and brings heightened benefits in the authorization cycle to cashless transactions by decreasing the vend time and reducing the operational costs to perform cashless vending.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a shopping cart vending machine according to embodiments of the present disclosure;

FIG. 2 illustrates a control system within the shopping cart vending machine according to embodiments of the present disclosure;

FIG. 3 illustrates a state diagram for the control system according to embodiments of the present disclosure; and

FIGS. 4A through 4N illustrate display content for a user interface during various states of operation of the shopping cart vending machine according to embodiments of the present disclosure.

### DETAILED DESCRIPTION

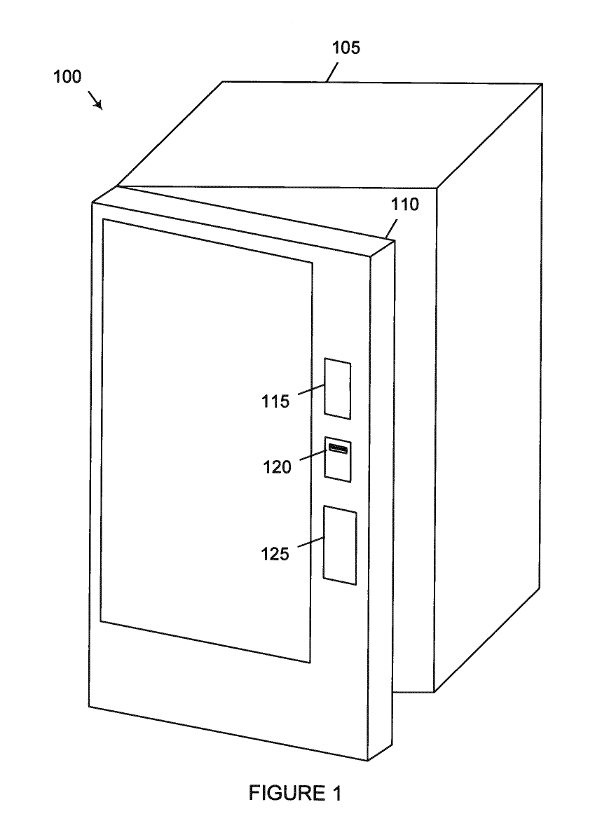

FIGS. 1 through 4N, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine currency handling system.

In embodiments of the present disclosure, a vending machine includes an advanced control system that employs a “shopping cart” vend transaction process. The shopping cart vend transaction can be analogous to shopping cart paradigms employed for Internet-based purchases. In the shopping cart vend transaction, a customer selects one or more products to purchase. The selected products are added to a virtual “shopping cart” until the customer decides to “check-out” in order to purchase the selected products. During check-out, the customer is able to tender payment and, subsequently, receive delivery.

Multi-vend transactions are facilitated by a change to the order of selection and payment in the vending machine. Conventional multi-vending typically employs a product-selection-before-payment process in which the order is: insert money, get product, then insert money again, and get second product again. Therefore, the product-selection-before-payment process is time consuming, tedious, and not customer friendly. Furthermore, the product-selection-before-payment process is not well suited for cashless multi-vend transactions. Cashless multi-vend transactions work poorly in the vending industry because the general solution currently involves one product selection and one payment authorization for each transaction. As a result, a separate credit/debit card authorization is performed per product selection made, which extends the time it takes a customer to purchase multiple products from the vending machine. The multiple card authorizations also increase operator costs since vending machine operators pay charges to the merchant account holder for each cashless payment authorization. The “shopping cart” format provides multi-vend transactions that are more customer and operator friendly. A “shopping cart” workflow program allows the customer to select N products into the cart, accumulate the total price, and perform a single credit card authorization for all of the selected products. The shopping cart vend process provides a true multi-vend that benefits the customer with ease and the vending machine operator with cost efficiencies.

The shopping cart vend process also enables discounting in a manner visible to the consumer, another true benefit. For example, when each product is placed into the shopping cart, a discount can be provided and displayed to the customer. Similarly, product promotion through discounts can be offered, such as encouraging the purchase of a soft drink when a bag of chips is selected, and offering a discount if both items are placed into the shopping cart. Product promotions can be dynamic and tied to specific product promotion screens at time of purchase.

FIG. 1 illustrates a shopping cart vending machine according to embodiments of the present disclosure. Although certain details will be provided with reference to the components of the vending machine 100 of FIG. 1, it should be understood that other embodiments may include more, less, or different components. The vending machine 100 is configured to implement a “shopping cart” paradigm for single- or multi-vend vending machine transaction process flow. In this example, vending machine 100 includes a cabinet 105 and a service door 110. The cabinet 105 and the service 110 form an enclosure. The vending machine 100 can store a plurality of products for sale via a vending operation. The service door 110 is pivotally mounted to the front of the cabinet 105. In certain embodiments, the service door 110 extends across the front face of the vending machine 100. In certain embodiments, the service door 105 extends across a portion of the front of the vending machine 100. In certain embodiments, the service door 105 includes two portions rotatably mounted on opposite sides of the front of the vending machine 100. The two portions can be of equal or unequal sizes and mounted to rotate (e.g., swing) open in opposite directions.

The vending machine 100 includes a user interface 115 and payment system 120. In certain embodiments, the user interface 115 is mounted on the service door 102. The user interface 115 includes a display configured to provide information in a graphical and/or textual format. In one example, the display is a touch screen liquid crystal display (“LCD”). The payment system 120 can be mounted within the service door 110. In certain embodiments, the payment system 120 and the user interface 115 form a single integrated unit. The payment system 120 includes a bill validator, a coin acceptor, a credit card reader, a cashless payment device reader, or any combination thereof. The credit card reader can be configured to read credit cards and debit cards. The cashless payment device reader can be a reader of fobs, tags, tokens, and the screen of a user device, such as a screen of a smart-phone. The payment system 120 receives currency, coins or other forms of payment, from the customer and returns change as necessary.

The vending machine 100 includes an access port 125. The access port 125 can be located within the service door 110 or on a panel of the cabinet 105 of the vending machine 100. The access port 125 provides access to a delivery receptacle mounted within the service door 110 or in the cabinet 105. The access port 125 includes a delivery door or other mechanical system (e.g., rotatable delivery receptacle open on one side) for controlling and restricting customer access into the delivery receptacle, the interior of the vending machine, or both. In some vending machine configurations, such as when the vending machine 100 is a helical coil snack vending machine, the access port 125 can be located near the bottom of the vending machine 100 and extend across most of the width of the vending machine 100. The access port 125 can be disposed below a large glass window allowing the contents within the cabinet to be viewed, or below a large LCD selectively presenting images of products available for vending or advertisements. Other vending machine designs, in particular beverage vending machines, have X-Y product retrieval and delivery mechanisms and a glass or substantially transparent front or large LCD front, but can include an access port 125 to the side, at a height convenient to the customer for product retrieval without bending over.

Those skilled in the art will recognize that the complete structure of a vending machine is not illustrated in the drawings, and the complete details of the structure and operation of the vending machine is not described in the present disclosure. Instead, for simplicity and clarity, only so much of the structure and operation of a vending machine as is unique to the present disclosure or necessary for an understanding of the present invention is illustrated and described.

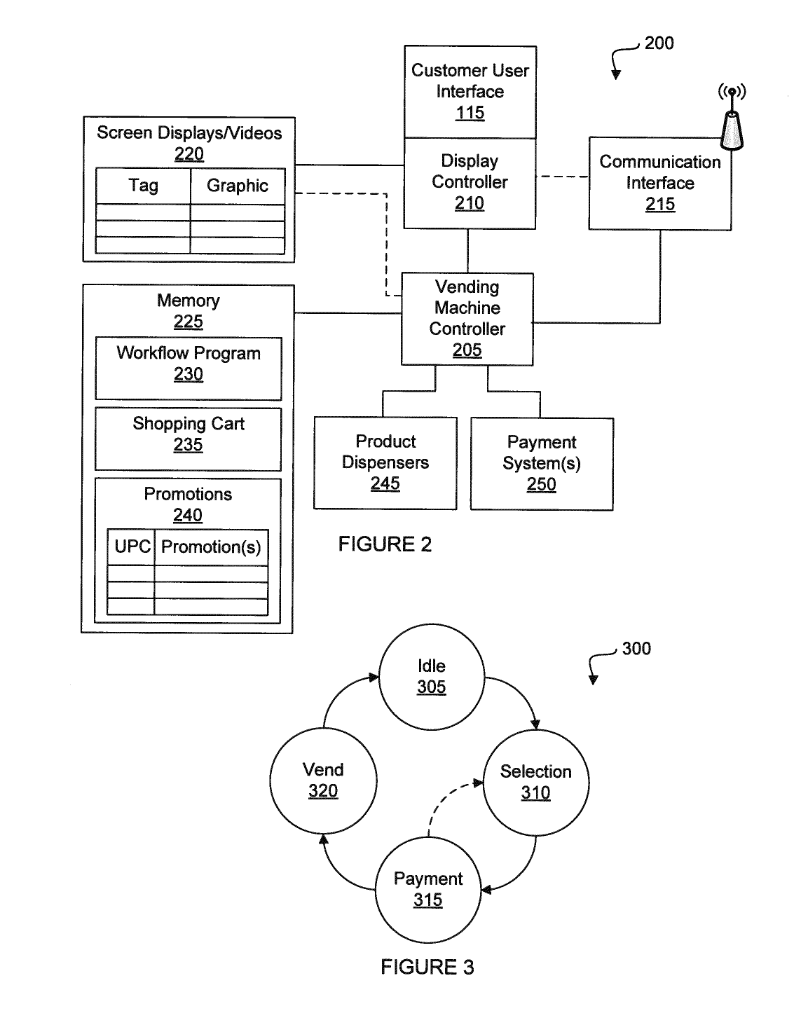

FIG. 2 illustrates a control system within the shopping cart vending machine 100 according to embodiments of the present disclosure. Although certain details will be provided with reference to the components of the control system 200 of FIG. 2, it should be understood that other embodiments may include more, less, or different components.

The vending machine 100 includes control system 200. The control system 200 includes processing circuitry configured to enable the vending machine 100 to implement the shopping cart vend process. The control system 200 includes a programmable vending machine controller (“VMC”) 205, a display controller 210, a communication interface 215 and one or more memories 220, 225.

The VMC 205 is coupled to and communicates with the display controller 210 for the user interface 115. The display controller 210 is coupled to user interface 115. The display controller 210 provides content for display on the user interface 115. The display controller 210 also detects customer contact with the touch screen, such as by detecting a physical contact by a human and the touch screen. The display controller 210 is coupled to and communicates with a display memory 220. The display memory 220 contains the content for display on the user interface 115, such as screen displays and videos. During a vend transaction and between transactions, the display controller 210 accesses media content for display stored in display memory 220 and renders that media content (i.e., screen displays and videos) on the user interface 115. The VMC 205 is optionally coupled to and communicates with display memory 220. The content for display, screen display graphics and videos, is stored in display memory 220 in exclusive association with a “tag” or unique identifier employed to access the respective content for display on the user interface 115. The display controller 210 also is optionally coupled to a communication interface 215, enabling communication with an external device.

The display memory 220 may include any suitable volatile or non-volatile storage and retrieval device(s). For example, the display memory 220 can include any electronic, magnetic, electromagnetic, optical, electro-optical, electro-mechanical, and/or other physical device(s) that can contain, store, communicate, propagate, or transmit information. The display memory 220 can store data and instructions for use by the display controller 210.

The VMC 205 is coupled to and communicates with communication interface 215. The communication interface 215 enables the control system 200 to transfer data to external devices, such as a handheld computer, a network operations center, or another vending machine. Communication may be by wireless data transfer, local area network Internet communication, or through an access port provided in the vending machine 100, such as Universal Serial Bus (“USB”). Communication with devices external to the vending machine 100 allows the for update of the media content displayed during a vend transaction, for the update of the programming of the vending machine 100, for transfer of data including operational data such as sales, remaining inventory or the operational status of various subsystems, and allows for the coordinated and common operation of multiple vending machines.

The VMC 201 also is coupled to or includes another memory 225. While shown as separate from VMC 205, memory 225 may be implemented within the same integrated circuit as VMC 205. In addition, memory 225 and display memory 220 may be included within a single memory unit, such as partitioned sectors within a single memory unit. The memory 225 may include any suitable volatile and/or non-volatile storage and retrieval device(s). For example, the memory 225 can include any electronic, magnetic, electromagnetic, optical, electro-optical, electro-mechanical, and/or other physical device(s) that can contain, store, communicate, propagate, or transmit information. The memory 225 can store data and instructions for use by the VMC 205. Additionally, the memory 225 can store information related to the object to which the VMC 205 is attached, such as product information, promotion information, product inventory, co-located vending machine status, event history, maintenance history, and so forth. Memory 225 stores the workflow program 230 used to control the vending machine's operations during a vend transaction, a “shopping cart” data structure 235 that holds identifiers for product selections (e.g., the product's Universal Product Code (“UPC Code”)) during the vend transaction, and optionally, a table 240 of promotions. In one example of table 240, the promotions are associated with and organized by the UPC Code for product selections.

The VMC 205 is coupled to and communicates with one or more product dispensers 245 (e.g., helical coils or an X-Y product retrieval mechanism) and payment system 120. Payment system 120 is optionally coupled to the communication interface 215. The communications interface 215 enables communication between the payment system 250 and an external facility, such as an account server, bank or credit card authorization center. The payment system 120 may include a coin mechanism, a bill validator/recycler, a magnetic stripe card reader, a cashless payment device reader (e.g., reader of fobs, tags, tokens, and screen of user devices), or any combination thereof. The VMC 205 receives signals from and controls the operation of product dispensers 245 and payment system 120.

Those skilled in the art will recognize that the complete structure and operation of the control system 200 is not shown or described herein. Instead, for simplicity and clarity, only so much of the complete structure and operation of the control system 200 as is unique to the present disclosure or necessary for an understanding of the present disclosure is shown and described.

FIG. 3 illustrates a state diagram 300 for the control system 200 according to embodiments of the present disclosure. The states illustrated in FIG. 3 correspond to the VMC 205 and other components of the vending machine 100 processing a vend transaction when the VMC 205 executes workflow program 230.

Transaction processing begins in an idle state 305, during which loops or series of media content are displayed on the customer user interface 115. The media content may include promotions (e.g., advertisements tied to the products available within the vending machine 100), any other type of advertisement, as well as instructional content (screen displays informing the customer of how to use the customer user interface 115 and vending machine 100). The media content can be stored in memory 220 and displayed on user interface 115. In certain embodiments, the user interface 115 uses a simplified Application Programming Interface (API) for content rendered by an animation or other display software such as a FLASH platform sold by ADOBE Systems Incorporated.

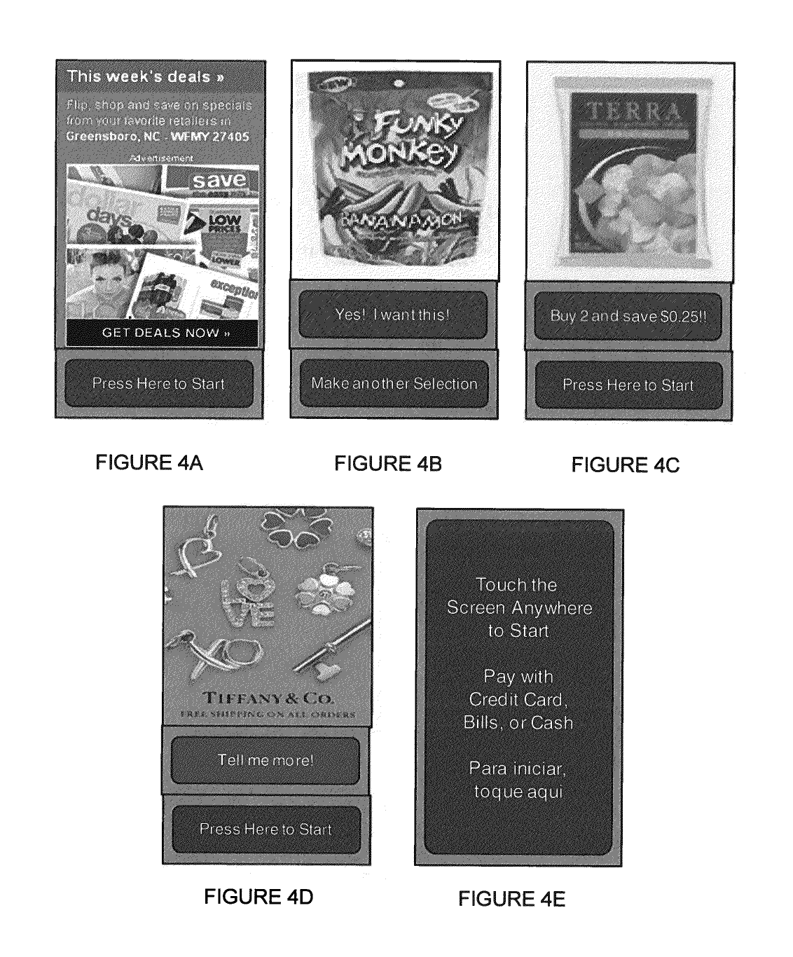

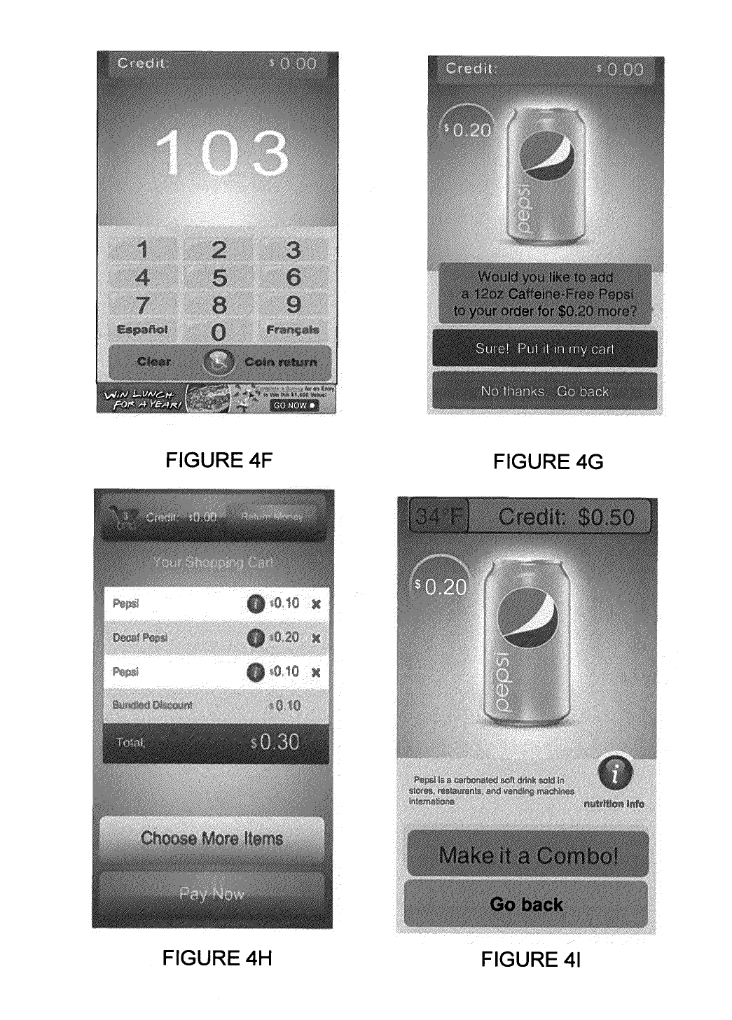

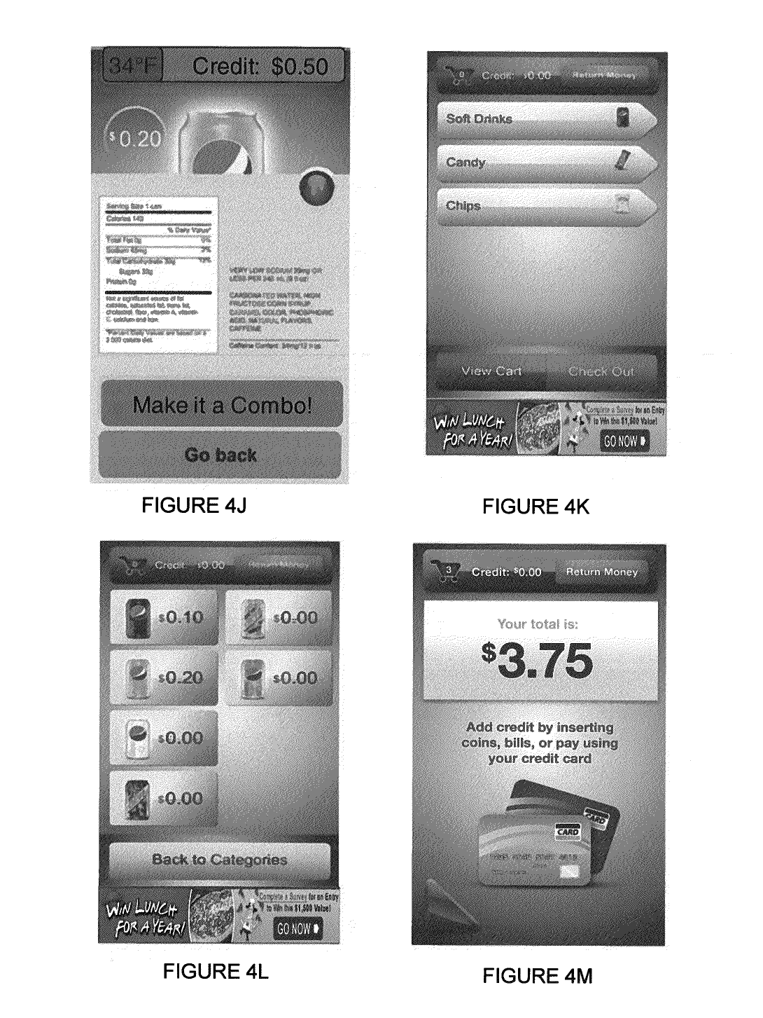

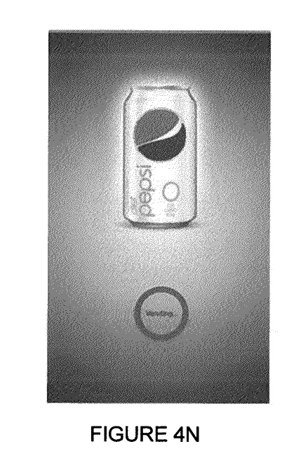

The managed loop of content may include static images (e.g., digital signs or the type of images displayed during previews at movie theaters), simple non-interactive FLASH animations, simple interactive FLASH content, fully interactive FLASH content, and full-screen video. The advertising and promotional content may be interleaved and/or overlaid with instructional content. FIGS. 4A through 4E illustrate media content for display on the user interface 115 during an exemplary idle loop. For example, FIG. 4A illustrates a simple static advertisement, while FIGS. 4B and 4C illustrate different promotions and FIG. 4D illustrates an interactive advertisement. The idle state looped content is designed to attract customer attention to machine with motion and animation, and to ensure that customers know what to do in order to initiate a vend transaction. For example, FIGS. 4A and 4C can illustrate a display including a “Press Here to Start” button.

FIGS. 4A through 4E illustrate, in order, an exemplary looped sequence of screen displays for user interface 115. For example, the static advertisement of FIG. 4A can be displayed for 3 seconds, the promotions of FIGS. 4B and 4C can be displayed for 5 second each, the interactive advertisement represented by the screenshot of FIG. 4D can be displayed for 4 seconds, and the instructional content of FIG. 4E can be displayed for 3 seconds before the loop returns to begin again with the content of FIG. 4A. In certain embodiments, the instructional screen of FIG. 4E is interleaved between two advertisements. In addition, instructions are overlaid on other content as illustrated by the “Press Here to Start” user control shown in FIGS. 4A, 4C and 4D, the “Make Another Selection” user control shown in FIG. 4B, the “Yes! I want this!” and “Buy 2 and save $0.25” user controls shown in FIGS. 4B and 4C, respectively, and the “Tell me more!” user control shown in FIG. 4D.

Each advertisement, promotion and instruction screen, is individually scheduled within the managed loop of content designated for display on the user interface 115. A third party can set the content, the position of the content within the loop, set the number of occurrences for each media content item within a loop (i.e., whether repeated), and the number of seconds to run each content item. Simplified FLASH programming makes altering the content of the loop relatively easy for third parties, so that new sets of content may be programmed and uploaded to the vending machine as a package via communication interface 215, over-the-air (OTA), wirelessly, or via a USB connection.

During operation, the vending machine control system 200 can gather statistics while the loop displays. The control system 200 can track how often the loop was shown, how many advertisements or promotions were “clicked through” (e.g., had an associated user control actuated), and how many promotions drove or related to a sale. All “clicks” (actuation of a displayed user control) are time-stamped, for later review relative to the loop content being displayed at that time. Advertisement statistics may thus be retrieved as consumer insight data records, such as time-stamped and linked displays, clicks, click-throughs, and purchases. The vending machine time-stamps provide traceability via consumer insight data. The vending machine 100, such as through the control system 200, can base the advertising rate on the control system 200 resources used, such as based on a simple ad not associated with a product in the machine, an advertisement for an out-of-stock product normally sold by the machine, an advertisement for a product in-stock within the machine that can be added to cart, whether the advertisement got clicked, and the time of the click, and so forth.

The “shopping cart” vend operation framework shown and described in the present disclosure enables promotional content to be displayed on the user interface 115 to influence or otherwise directly drive purchases. For example, the shopping cart vending operation can influence a consumer to add items to the shopping cart by actuation of either of the “Yes! I want this!” and “Buy 2 and save $0.25!” user controls shown in FIGS. 4B and 4C, respectively. Actuation of either user control causes the control system to add the UPC Code for the corresponding product(s) to the shopping cart 235.

The control system 200 supports a dynamic revenue model for advertising and promotions, having different rates applied to advertisements and promotions that are interactive, depending on whether the corresponding product is out-of-stock within the vending machine 100.

When the loop content is being displayed in the idle state 305 and a customer actuates a user control on the customer user interface 115 designed to initiate a product selection (e.g., the “Press Here to Start” user control in FIGS. 4A and 4C, either of the “Yes! I want this!” or “Make Another Selection” user controls in FIG. 4B, the “Buy 2 and Save $0.25!” user control in FIG. 4C, or any part of the screen in FIG. 4E), the workflow program 230 causes the control system to transition to the selection state 310.

FIG. 4F illustrates a display for the user interface 115 in the selection state 310. A customer can add multiple products to the shopping cart using a numeric code uniquely identifying the desired product or the product column or dispenser location containing the desired product. To minimize the number of key presses required, entry of a valid product selection code immediately places the corresponding product selection into the shopping cart 235. Workflow program 230 may include and employ a planogram (a mapping of the products available in each product dispenser) that provides a richer product selection model via pictures, in addition to product selection by numeric code entry. Upon selection of an item, the UPC Code for that item is added to the shopping cart data structure 235.

The display memory 220 can include a plurality of instructions that enable text or images displayed via the user interface 115 to change dynamically and provide for clearing a product selection entry and returning deposited money. For example, the user interface 115 can provide user controls that enable the language in which text is displayed on the user interface 115 to change dynamically, to progress from a product selection, clearing of the selected product, additional selections, checking out and returning of deposited or excess money. In certain embodiments, the user interface is disposed no higher than at a height of forty-eight inches above the floor. When all user controls are positioned below forty-eight inches above the floor on which the vending machine rests, the Americans with Disabilities Act (“ADA”) control shown in FIG. 4F (the button between “Clear” and “Coin Return”) is not necessary.

Operation of the vending machine 100 in the product selection state via the user interface 115 shown in FIG. 4F is intuitive. The touch screen contacts are designed and programmed to ensure that every key press and customer interaction (e.g., actuation of a user control) is deliberate. In the product selection state 310, the workflow program 330 employs a flexible model that enables nutritional information to be integrated directly with the selection process. For example, FIG. 4J illustrates a display in which nutritional information is displayed together with product selection buttons. The workflow program 230 is configured to recognize when a customer selects a product that is associated with a combo group promotion 240 and to up-sell (e.g., display media content offering a discount for a multi-vend transaction). The workflow program 230 is configured to allow a customer to add a single product selection to the shopping cart, and without penalty, and complete a single-vend transaction. That is, the vending machine 100 does not penalize a customer that selects a product that is part of a combo promotion, declines the promotional offer and uses the shopping cart to purchase that single product selection.

The control system 200 supports a dynamic revenue model for advertisements and promotions displayed during the selection state 310. The user interface 115 is configured to display banner promotions. FIG. 4G illustrates that a plurality of banners can be located at the bottom of the customer user interface display, enabling direct insertion of promoted items into the shopping cart when activated (i.e., pressed). FIG. 4G illustrates that a banner can provide customers an opportunity to confirm or reject the promotional selection.

In certain embodiments, once a product selection is added to the shopping cart 235, the user interface display changes to a display of the current contents of the shopping cart. The user interface 115 provides a user control to enable the consumer to make additional product selections. In certain embodiments, once a product selection is added to the shopping cart 235, the user interface display remains in a product selection and advertising mode, such as offering additional promotions, providing suggested purchase selections or enabling general product selections. The user interface 115 provides a user control to cause the display to render the current contents of the shopping cart. The listing of UPC Codes within shopping cart data structure 235 is employed by the control system 200 to generate a display of items within the cart, such as illustrated by FIG. 4H. The item and price are displayed together with a first user control, such as a red “x”, for removing that particular item (only) from the shopping cart and a second user control, such as an “i” button, for displaying nutritional information about the selected product. Any applicable discount for combo purchases or bundled items is shown directly on the shopping cart display, as illustrated in FIG. 4H.

FIG. 4H illustrates a “Choose More Items” user control. By selecting the “Choose More Items” user control, the display controller 210 returns the user interface display screen to the main selection screen of FIG. 4F to allow the customer to select additional purchases for a multi-vend. A “Pay Now” user control allows the customer to check out (i.e., complete the purchase of the selected products). In certain embodiments, the list of product selections within the shopping cart is configured to be a set of user controls, such that if one item listing is touched (e.g., “Decaf Pepsi”), a different user interface screen will display, showing a picture and description of the item selected, for example.

Actuation of the product information user control (the “i” button in FIGS. 4H and 4I) associated with a particular item in the shopping cart, or pictured on the screen, causes the user interface display to show nutritional information in one of several available formats. That is, in response to a consumer selecting the “i” user control, the display controller 210 causes the user interface 115 to display nutritional information in one of several formats. Optionally, calories only may be shown directly in the shopping cart display, as shown in FIG. 4H.

In certain embodiments, a planogram in the control system 200 provides richer user interface options for the product selection consumer interface display screens. As shown in FIG. 4K, the user interface 115 may be enhanced by an image “catalog” for all products available in the vending machine, wherein each selection is tagged by one or more categories (e.g., soft drinks, candy, chips, sugar free, chocolate, no nuts, etc.), allowing for more flexible organization of product selection information on the user interface display. Actuation of one of the category user interface controls in FIG. 4K causes user interface 115 to bring up a display of all items tagged with that category, as shown in FIG. 4L. For example, in response to the consumer selecting and pressing one of the category user interface controls, the display controller 210 causes the user interface 115 to display items included within the selected category. For categories with large numbers of items, the user interface display can contain scrolling or page up and page down user interface controls. In certain embodiments, the consumer can scroll through the products by contacting the display screen and dragging the products in one of a number of directions, such as moving the display of products vertically or horizontally. As with the numeric code product selection screen of FIG. 4F, banner advertisements and promotions are maintained at the bottom of each screen and may be pressed at any time. When enabled by the planogram, product selection by the customer results in the corresponding product being immediately added to the shopping cart (see FIG. 4H). Additionally, the product can be removed from the shopping cart before payment is processed.

When in the product selection state 310, the user interface 115 displays the customer's current credit, provides a user control for displaying the current shopping cart contents, provides a user control for returning credit, provides language choices and dynamic (on-the-fly) language changes, and displays the current temperature inside the vending machine, as shown in FIGS. 41 and 4J. In certain embodiments, only one button is necessary to provide language choices. The user interface 115, in the selection state 310, provides an ADA user control if one or more user controls are not located below forty-eight inches above the floor on which the vending machine rests.

When the customer has made all product selections desired, the customer may indicate readiness to complete the vend transaction by pressing the “Pay Now” user control in FIG. 4H or the “Check Out” user control in FIG. 4K. In response to the customer's indicated readiness to complete the vend transaction, the control system transitions to the payment state 315. That is, in response to detecting a selection of the “Pay Now” user control, or the “Check Out” user control, the control system 200 transitions to the payment state 315 to enable the consumer to complete the transaction and provide payment.

The vending machine 100 is not strictly a “post pay” system, in which payment is accepted and processed only after the customer completes all product selections. Instead, cash or cashless payments may be inserted or applied by the customer at any time. Accordingly, the control system 200 is configured to determine whether payment has been made before, during and after product selection. That is, the VMC 205 can continually monitor if payment is submitted via the payment system 120 or if the user selects a user control to enter payment. Additionally, in the payment state, the customer may return to the selection state 310 to make further selections or to change existing selections. Under the process flow of the present disclosure, payment need not occur at any particular time during the vend cycle. Instead, payment (coin, bill, or credit card, or a combination thereof) is accepted at any point in the vend transaction process, requiring only sufficient credit to pay for all product selections in the cart before the vending machine delivers the selected products. For example, in response to actuation of a “Vend Products” user control (not shown), if sufficient credit is not available at the time the customer attempts to initiate product delivery, then the control system will prompt the user to continue adding credit until sufficient credit has been received. In response to a customer inserting a credit/debit card (or other cashless payment means) prior to completing product selections, the control system 200 can capture the information necessary to complete the transaction. The control system 200 can store that the captured information in the memory 225 until needed. Alternatively, the control system 200 can establish preauthorization credit of either N times the maximum vend price, or maximum credit available on card, whichever is less. In certain embodiments, split tender is accepted, and coins, bills, and cards (and other cashless payment forms) can be freely intermixed.

The payment state 315 includes an intuitive cart confirmation prior to “check out.” The intuitive cart check out confirms credit and instructs users on which payment devices to use, and communicates payment device status (e.g., “Use Correct Change”, “Accepts $1 and $5”, etc.). The monetary status is displayed clearly and completely in customer user interface 115, including low coin/change availability, bill recycler status, and cashless payment reader online/offline. In payment state 315, a payment screen (illustrated in FIG. 4M) can, for example, show an animation sequence directing the customer to available payment systems in the vending machine 100. In certain embodiments, the animation is associated with indicator lighting in the respective payment area. The payment screen remains active and displayed on the customer user interface until sufficient credit is reached. The payment screen displayed on the customer user interface includes a “Return Money” or “Cancel Credit” user control that, upon customer actuation, cancels the vend transaction and empties the shopping cart.

Upon completion of payment processing, the control system 200 transitions to a vend state 320. In vend state 320, the customer user interface communicates the status of product delivery, illustrated in FIG. 4N. The user is provided with some indication of what should be happening within the vending machine 100. In certain embodiments, during product delivery, the customer user interface displays some short content, such as news blurbs, local weather forecasts, customized office announcements, or Amber alerts (which can also be displayed during the idle state 305).

A shopping cart vend transaction order-of-processing brings familiar purchasing sequences and views from grocery/retail stores and the like to the consumer in vending transactions, allows multi product purchase discounting, introduces a “virtual receipt” to the consumer at a vending machine (the screen output can look like a grocery store receipt), and brings heightened benefits in the authorization cycle to cashless transactions by decreasing the vend time and reducing the operational costs to perform cashless vending. At the completion of product delivery, the control system immediately transitions to idle state 301 in order to get the next customer started as quickly as possible.

Although various features have been shown in the figures and described above, various changes may be made to the figures. For example, the size, shape, arrangement, and layout of components shown in FIGS. 1, 2 and 4 are for illustration only. Each component could have any suitable size, shape, and dimensions, and multiple components could have any suitable arrangement and layout. Also, various components in FIGS. 1 and 2 could be combined, further subdivided, or omitted, and additional components could be added according to particular needs. For instance, a system using multiple vending machines could be supported by only one control system. Further, each component in a device or system could be implemented using any suitable structure(s) for performing the described function(s). In addition, while FIGS. 3 and 4 illustrate various series of steps or states, various steps in FIGS. 3 and 4 could overlap, occur in parallel, occur multiple times, or occur in a different order.

As used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A vending machine transaction control system, comprising:
a memory configured to store one or more product identifiers indicating customer product selections for a current vend transaction; and
a controller containing or connected to the memory and configured to be coupled to a user interface at which customer product selections are received, at least one payment system at which payment for a vend transaction is accepted, and one or more product dispensers from which products are dispensed to the customer in response to at least one control signal from the controller, the controller configured to accept customer product selections for the current vend transaction prior to prompting the customer to enter payment for the current vend transaction.

2. The vending machine transaction control system according to claim 1, wherein the controller is configured to prompt the customer to enter payment for the current transaction after all product selections for the current vend transaction have been entered by the customer.

3. The vending machine transaction control system according to claim 1, wherein the controller is configured to receive signals from the at least one payment system indicating one or more of an amount of cash inserted into the at least one payment system by the customer and credit/debit account information communicated to the at least one payment system by the customer, and wherein the customer enters payment by inserting cash or communicating credit/debit account information.

4. The vending machine transaction control system according to claim 1, wherein the controller, in response to receiving signals on a connection to the user interface indicating a current customer product selection for the current vend transaction, is configured to add a product identifier corresponding to the current customer product selection to an aggregation, stored within the memory, of product identifiers corresponding to prior customer product selections, if any, for the current vend transaction.

5. The vending machine transaction control system according to claim 4, wherein the controller is configured to cause display on the user interface of product selections corresponding to the product identifiers aggregated within the memory for the current vend transaction.

6. The vending machine transaction control system according to claim 4, wherein controller is configured to enable the customer to remove at least one product selection corresponding to one of the product identifiers aggregated within the memory for the current vend transaction.

7. The vending machine transaction control system according to claim 1, wherein the controller is configured to cause display on the user interface of a user control for indicating that all customer product selections for the current vend transaction have been entered, and to prompt the customer to enter payment for the current vend transaction in response to actuation of the user control.

8. A vending machine including the vending machine transaction control system according to claim 1, the vending machine further comprising:
an enclosure configured to store a plurality of products;
the user interface, coupled to the controller;
the at least one payment system, coupled to the controller; and
the one or more product dispensers, coupled to the controller.

9. A vend transaction process within a vending machine, the process comprising:
prior to prompting the customer to enter payment within any payment system in the vending machine, receiving at least one customer product selection for a current vend transaction at a user interface within the vending machine configured to receive customer product selections for products available to be dispensed by the vending machine;
aggregating one or more product identifiers corresponding to customer product selections for the current vend transaction;
in response to receiving a customer input from the customer indicating that all customer product selections for the current vend transaction have been entered, prompting the customer to enter payment for the current vend transaction in at least one payment system in the vending machine; and
upon receiving payment for the current vend transaction, dispensing products corresponding to the one or more aggregated product identifiers.

10. The vend transaction process according to claim 9, further comprising:
prompting the customer to enter payment for the current transaction at one of the user interface and the at least one payment system.

11. The vend transaction process according to claim 9, further comprising:
after prompting the customer to enter payment for the current transaction, receiving one or more of cash inserted into the at least one payment system by the customer and credit/debit account information communicated to the at least one payment system by the customer.

12. The vend transaction process according to claim 9, wherein aggregating one or more product identifiers corresponding to customer product selections for the current vend transaction comprises aggregating the product identifiers as the customer product selections are entered in the user interface without prompting the customer for payment for a prior customer product selection.

13. The vend transaction process according to claim 9, further comprising:
displaying, on the user interface, product selections corresponding to the product identifiers aggregated for the current vend transaction.

14. The vend transaction process according to claim 9, further comprising:
enabling the customer to remove at least one product selection corresponding to one of the product identifiers aggregated for the current vend transaction.

15. The vend transaction process according to claim 9, further comprising:
displaying, on the user interface, a user control for indicating that all customer product selections for the current vend transaction have been entered; and
prompt the customer to enter payment for the current vend transaction in response to actuation of the user control.

16. A vending machine control system, comprising:
a display controller configured to generate information for display on a user interface and to detect inputs from a customer; and
a vending machine controller coupled to the display, the vending machine controller configured, for a single vend transaction, to accept a plurality of customer product selections entered on the user interface prior to prompting the customer to insert cash into or provide credit/debit account information to a payment system within the vending machine, wherein the vending machine controller provides a virtual shopping cart enabling the customer to aggregate one or more product selections for the single vend transaction and to pay for the one or more product selections after entering all product selections.

17. The vending machine control system according to claim 16, wherein the display controller is configured to cause the user interface to display, from an image catalog stored in the vending machine and comprising at least one image for each product sold by the vending machine, at least one of
an image for each of a plurality of products available to be dispensed by the vending machine, and
an image for each of a plurality of categories of products available to be dispensed by the vending machine,
wherein each image for a product sold by the vending machine is tagged to correspond to one or more categories of products.

18. The vending machine control system according to claim 16, wherein the at least one payment system is configured to accept payment from the customer before, during, and after entry of the plurality of customer product selections.

19. The vending machine control system according to claim 16, wherein the vending machine controller is configured, in response entry a customer product selection at the user interface, to add a product identifier corresponding to the customer product selection to the virtual shopping cart.

20. The vending machine control system according to claim 16, wherein the display controller is configured to remove at least one product identifier from the virtual shopping cart in response to detecting actuation of a user control displayed on the user interface for canceling a prior customer product selection.
